(19) United States
(12) Patent Application Publication
(10) Pub. No.: US 2002/0057687 A1
(43) Pub. Date: May 16, 2002

(54) High speed interconnection for embedded systems within a computer network

(75) Inventors: Rainer Birkenmaier, Schaer (DE); Oliver Grabner, Munchen (DE); Holger Kufner, Schweinfurt (DE)

Correspondence Address: STAAS & HALSEY LLP, 700 11TH STREET, NW, SUITE 500, WASHINGTON, DC, 20001, US

(73) Assignee: SIEMENS AKTIENGESELLSCHAFT, Munchen (DE)

(21) Appl. No.: 09/984,360

(22) Filed: Oct. 30, 2001

(30) Foreign Application Priority Data
Oct. 30, 2000 (DE) 00123673.6

(51) Int. Cl. H04L 12/28; H04L 12/56

(52) U.S. Cl. 370/389; 370/394

(57) ABSTRACT

For obtaining an efficient, high-speed and reliable protocol a protocol stack is developed that supports only functionality which is absolutely essential for the application. In particular, it ignores all those functions relating to use in long-distance networks. The inventive step firstly comprises the movement of a distributed synchronization in time of multiple computation systems from the application to the protocol stack for realization of a voting mechanism within the computer network and, secondly, the integration of this functionality in this efficient and reliable protocol.

### BACKGROUND OF THE INVENTION

The present invention relates to a process for transmitting data from a first system to a second system within a local area computer network using Ethernet communication technology and to a voting mechanism in an error-tolerant system within a computer network making use of such a process for transmitting data and, in particular, where a number of different computation systems carry out the same calculation and every result of a calculation from every computation system is transmitted to be compared to a voter system, the voter system compares the different results and reports a result of the comparison back to the different computation systems involved, and the computation systems do not start any further calculations until they have received the result of the voting process.

In the field of local Ethernet communication, modern computer networks, in particular in office communication, mainly use network protocols, in particular TCP/IP, which are not optimized for this specific type of communication, but are designed predominantly for long-distance networks.

The overhead produced in consequence slows down the overall communication process. In addition, special mechanisms have to be modeled at the application level to achieve a synchronization of communications systems. Essentially, this results in three problems:

(a) inefficient communication, particularly in response times and data throughput rate, but also in other areas of the required protocol elements.

(b) to provide reliable communication, when data are transmitted, they either arrive correctly or a corresponding error is signaled; in either case, the application has to be informed of the data transmission status.

(c) little support for distributed synchronization of processes for voting mechanisms in error-tolerant systems.

In the past, an improvement in the efficiency of communication has been achieved mainly by using faster hardware. Another approach is to attempt to improve the efficiency by reimplementation of existing protocol stacks or parts of protocol stacks. However, in that case, the fundamental problem still remains that the protocol itself is not optimized for the purpose.

Furthermore, reliable communication nowadays is either provided by the protocol stack or must be implemented by the application itself. Similarly, distributed synchronization has up until now been achieved only at the application level causing problems with respect to implementation and performance.

### SUMMARY OF THE INVENTION

An object of the present invention is thus to provide a process for transmitting data within a local area computer network that improves efficiency and reliability of the transmission.

The aforementioned object is achieved according to the present invention with a process for transmitting data from a first system to a second system within a local area computer network using Ethernet communication technology, where existing protocol stacks within local Ethernet communication are redesigned in a way that functions relating to use in long-distance networks, in particular routing capability and/or complex name services such as DNS for TCP/IP and/or multiple checksums, are eliminated by data packets being identified by a unique identification-number built of an address existing in Ethernet protocol, in particular Medium-Access-Control-addresses, and of a sequence-number, received packets are acknowledged to the sending system by acknowledge-IDs, and a data packet is retransmitted by the sending system on timeout for an acknowledge-ID to be received.

According to the present invention those functions can be used more efficiently and more easily if they are implemented in the protocol stack itself.

In a first advantageous embodiment of the process for transmitting data according to the present invention it has turned out to be especially advantageous if unique identification-numbers are generated by increasing the identification-number of an actual packet for obtaining a unique identification-number for every following packet.

In another advantageous embodiment of the process for transmitting data according to the present invention the sending system of a data packet frees memory for this data packet within a data buffer only after having validly received the corresponding acknowledge-ID.

Under these conditions it has turned out to be especially advantageous if the receiving system of a data packet forgets an identification-number of a data packet only in case of the identification-number being smaller than the one of the last acknowledged acknowledge-ID provided by a sending system.

Furthermore, it has turned out to be especially advantageous if a timeout for an acknowledge-ID to be received is calculated by a time a data packet was sent, a receive time of the sending system and a maximum processing time of the sending system to get a schedule and to start sending a data packet.

Preferably, the receive time is calculated from twice a maximum Ethernet travel time for a data packet plus a maximum processing time in the receiving system.

In another advantageous embodiment of the process for transmitting data according to the present invention an error of transmission is detected by a sending system on a number of retransmissions of a data packet exceeding a preset number of attempts. Alternatively, an error of transmission is detected by a receiving system on a timeout if an identification-number has to be kept longer than a preset time.

The advantages achieved with the present invention are especially valuable if every system within the local area computer network is an embedded system.

To handle the acknowledge-IDs efficiently they are transmitted as part of a data packet.

Under these conditions it has turned out to be especially advantageous if a data packet sent by a sending system also comprises the last acknowledged acknowledge-ID.

Another object of the invention is to implement a voting mechanism in an error-tolerant system within a computer network making use of the aforementioned process for transmitting data in a simple and efficient manner. This object of the present invention is achieved by a voting mechanism in an error-tolerant system within a computer network, where a number of different computation systems carry out the same calculation and every result of a calculation from every computation system is transmitted to a voter system to be compared. The voter system compares the different results and reports a result of the comparison back to the different computation systems involved, where the computation systems do not start any further calculations until they have received the result of the voting process, by a distributed synchronization in time of the different computation systems being implemented as part of a protocol stack for data transmission within the computer network.

In an advantageous embodiment of the voting mechanism according to the present invention a result of a calculation from a computation system being a requesting system within the network is transmitted to the voter system using a single system call that is not returned until the voting has been completed in the background and a result is present and fed back to the computation system.

By this feature it is achieved that the handling of a voting process is highly simplified. A single call is sufficient and the process of voting is processed in the background, and is transparent to the application. In known voting mechanisms a more critical factor is the fact that this procedure usually forces the application having to wait actively. To avoid this problem, in another advantageous embodiment of the voting mechanism according to the present invention a process that issued the system call is placed in a not-ready-queue within the computation system until the system call returns, thus, avoiding the computation system having to wait actively for the result of the voting process.

It has turned out to be especially advantageous if it is ensured that all the different computation systems involved send the result of the same calculation to the voter system.

To avoid a Single Point off Failure, the voter system comparing the different results and reporting a result of the comparison back to the different computation systems involved is distributed within the computer network.

Further advantages and details of the present invention are described in the following preferred embodiments together with the drawings.

### BRIEF DESCRIPTION OF THE DRAWINGS

Reference will now be made in detail to the preferred embodiments of the present invention, examples of which are illustrated in the accompanying drawings, wherein like reference numerals refer to like elements throughout.

FIG. 1 is a block diagram of a protocol stack according to the present invention embedded in Windows CE®.

FIG. 2 is a data structure diagram for a data packet.

FIG. 3 is a timing diagram for a data transmission according to the present invention.

FIG. 4 is a timing diagram for a data transmission according to the present invention with a data packet lost.

FIG. 5 is a timing diagram for a data transmission according to the present invention with an acknowledge-ID lost.

FIG. 6 is a block diagram of a voting mechanism with a system call according to the present invention.

### DETAILED DESCRIPTION OF THE PREFERRED EMBODIMENTS

The protocol stack within Ethernet communication in a computer network according to the present invention supports only functionality which is absolutely essential for the application. In particular, it ignores all those functions relating to use in long-distance networks, e.g. routing capability. The implementation is not only matched to local communication, but is also optimized to the communication technology being used, Ethernet. There is no need for any name service, such as DNS for TCP/IP. The Medium-Access-Control addresses MAC from Ethernet are used instead.

In traditional protocols, such as TCP/IP, mechanisms often exist which are used more than once, but whose duplicated utilization does not result in increased usefulness. For example, this is done in the checksums TCP/IP. These are used to check the correctness of the received data. At the Ethernet level, they are implemented in hardware and are thus virtually free of any latency time. TCP/IP, checksums are calculated again repeatedly at two further levels, which means additional and unnecessary complexity when Ethernet is used as a transport medium.

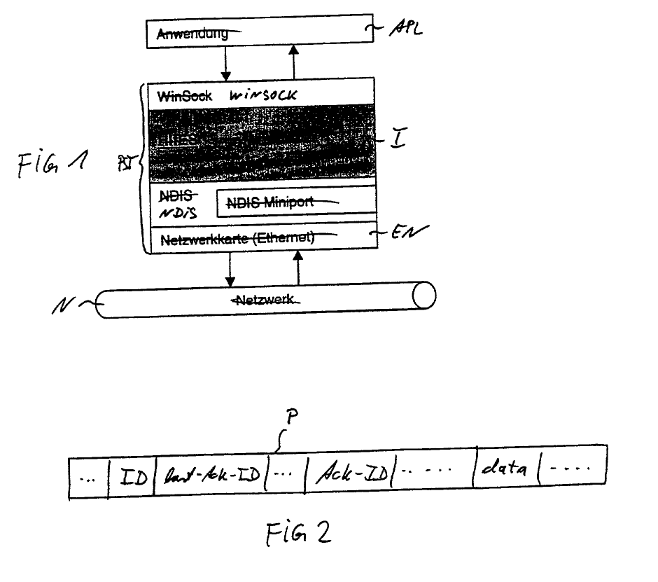

The present invention thus makes use of an extremely flat and hence highly efficient protocol stack as is shown in FIG. 1 which uses the example of Windows CE® to show how the protocol stack according to the present invention can be integrated in an operating system.

An application APL is shown that communicates via a protocol stack PST comprising the high speed interconnection protocol I of the present invention and Ethernet communication technology EN for connection with a computer network N.

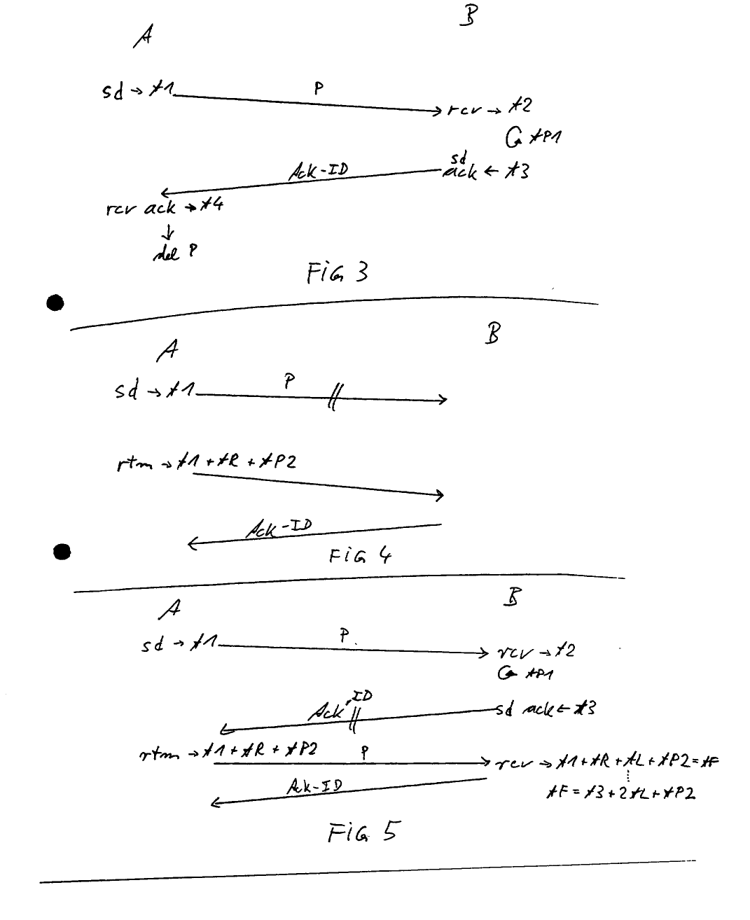

FIG. 2 shows an example of a data packet P which is used for high speed interconnection according to the present invention. Different systems within the computer network N transmit such data packets P for achieving high speed interconnection of those systems in a way that is explained below with reference to FIGS. 3 to 5.

The data packets P as shown in FIG. 2 are identified by a unique identification number ID built of the aforementioned MAC Ethernet address that is already in the Ethernet packet and a sequence number seq#. By using the Ethernet address addressing can be realized by making use of the Ethernet socket-interface.

Usually both communications systems A and B are sending as well as receiving systems. That is why it is advantageous if, as shown in FIG. 2, each data packet P, apart from application data, comprises an acknowledge identification number Ack-ID as well as the last acknowledge ID ‘last-Ack-ID’. The acknowledge information being part of a data packet makes the interconnection more efficient. Of course, it is also possible to send acknowledge information in a separate packet to the sending system A.

For explanation purposes the following description uses communications system A only as sending system and communications system B only as receiving system. Thus, in FIGS. 3-5 it is shown how data packets P are transmitted from a first system A as the sending system to a second system B as the receiving system.

The following time references are used in FIGS. 3-5:

ti time a data packet P is sent

t2 receive time of a receiving system

tR receive time of a sending system

tP1 maximum processing time in a receiving system

tP2 maximum processing time of a sending system to get a schedule and to start sending

t3 time the Ack is sent

t4 time the Ack is received

tL maximum Ethernet travel time of a data packet transmitted over the computer network N

FIG. 3 shows transmission of a data packet P working correctly without any packet loss. A communications system A sends ‘sd’ a data packet P at the time t1 which is received ‘rcv’ by a communications system B at the time t2. The received data packet is then processed by the receiving system B within a processing time tP1 before acknowledge information Ack-ID is sent ‘sd ack’ back to the communications system A at a time t3 where this acknowledge information is received ‘rcv ack’ at a time t4. The acknowledge information Ack-ID can be sent as part of a data packet P as shown in FIG. 2.

Each communications system A, B can comprise a buffer memory for storing the data of multiple data packets to be transmitted. A part of this buffer memory used for the data packet P having been sent is freed ‘del P’ only on receiving the correct acknowledge information Ack-ID.

FIG. 4 shows the same way of transmitting data according to the present invention but in a case of the data packet P being dropped during transmission to communication system B. As the sending system A does not receive an acknowledge information for the data packet P having been sent ‘sd’ during a time expected, it has to be retransmitted ‘rtm’ on timeout.

A timeout for an acknowledge-ID to be received is calculated by the time t1 the data packet P was sent, the receive time tR of the sending system A and the maximum processing time tP2 of the sending system A to get a schedule and to start sending a data packet according to the following formula:

timeout=t1+tR+tP2 (1)

Preferably, the receive time tR is calculated from twice a maximum Ethernet travel time tL for a data packet in addition with the maximum processing time tP1 in the receiving system B according to the following formula:

tR=2*tL+tP1 (2)

Therefore the timeout can be calculated as follows:

timeout=t1+2*tL+tP1+tP2 (3)

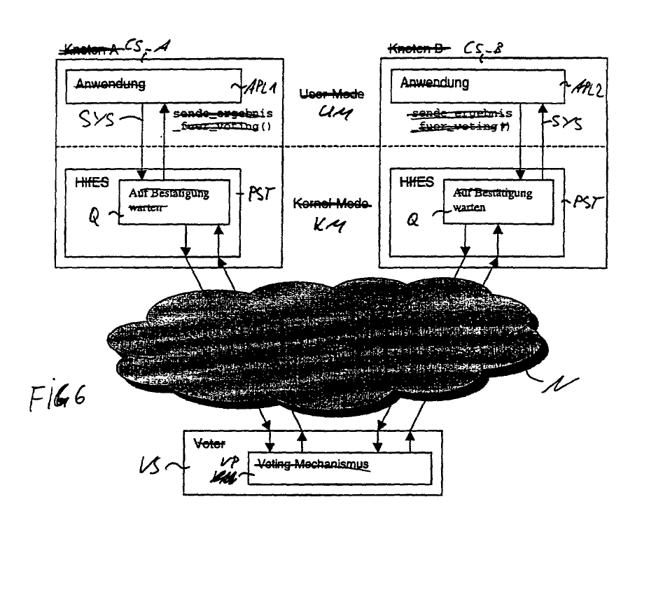

FIG. 5 shows the same way of transmitting data as in FIG. 3 according to the present invention in a case the data packet P having been transmitted correctly but the acknowledge information Ack-ID being dropped during transmission back to communication system A. As the sending system A does not receive an acknowledge information having been sent ‘sd ack’ during a time expected, the data packet P again has to be retransmitted ‘rtm’ on timeout as calculated in formulas (1) to (3).

When the receiving system B receives ‘rcv’ the data packet P for the second time it has to resend the acknowledge information Ack-ID but to take into consideration that the data packet P has already been received correctly. By the unique Ids of every data packet the receiving system B is able to recognize that the same data packet P has already been received earlier.

The time tF a data packet P is received for the second time by the receiving system B according to formula (1) is calculated as follows:

tF=t1+tR+tL+tP2 (4)

With formula (2) this can be transformed into:

tF=t1+3*tL+tP1+tP2 (5)

The time t1 is not known by the receiving system B but it can be calculated in worst case as

t1=t2−tL (6)

so that tF becomes

tF=t2+2* tL+tP1+tP2. (7)

With

t3=t2+tP (8)

it results the following formula for calculating the time tF of receiving a data packet P for the second time:

tF=t3+2*tL+tP2. (9)

The receiving system B forgets an identification number ID of a data packet P only in case of this ID being smaller than the last acknowledged Ack-ID provided by the sending system A as part of a data packet P according to:

ID=<last−Ack−ID. (10)

The sending system A on the one hand recognizes an error of the transmission on too many retransmits. Therefore a number of attempts is preset that must not be exceeded for a correct transmission of data packets P.

The receiving system B on the other hand recognizes a transmission error on timeout if an ID has to be kept too long.

An advantage of the data transmission according to the described invention in the field of reliable communication is that datagram communication is protected in the protocol itself as described above in FIGS. 3 to 5 in contrast, for example, to TCP/IP. Furthermore, protection mechanisms are used which are matched to the requirements of local communication. Under the conditions described above, on error the complete state of the system can be reconstructed in any case.

With the high speed and reliable interconnection as described above it is possible to implement a protocol which supports distributed synchronization for voting mechanisms. In a voting mechanism, as it is shown in FIG. 6, a number of different computation systems CS_A, CS_B send the result of a calculation which is intended to be compared to a voter system VS, all systems CS_A, CS_B and VS being communications partners within a local computer network N communicating as described above.

This voter system VS compares the results and reports the result of the comparison back to the different computation systems CS_A, CS_B involved. For this comparison, it is ensured that all the different computation systems CS_A, CS_B involved send the result of the same calculation to the voter system VS, and that they do not start any further calculations until they have received the result of the voting process VP.

In other words, the different computation systems CS_A, CS_B involved are synchronized in time. In the present invention, this voting mechanism is implemented in the protocol stack PST of the different computation systems CS_A, CS_B itself being part of the kernel mode KM or, in other words, of the operating system, e.g. Windows CE®.

The applications APL1, APL2 of the different computation systems CS_A, CS_B are located in the user mode UM and communicate with the protocol stack PST including the voting mechanism using a system call SYS of the type ‘send back result of voting’.

Thus, for a synchronization in time no system call SYS is returned until the voting has been completed and a result is present, which is fed back to the different computation systems CS_A, CS_B involved.

This essentially results in two advantages over an implementation in the application as is state of the art. Firstly, the handling of a voting process VP is highly simplified, a single system call SYS is sufficient and everything else is processed in the background (kernel mode KM), and is transparent to the application. However, a more critical factor is the fact that this procedure avoids the application having to wait actively. Instead of this the requesting process, as is normal for a system call, is placed in the not-ready queue Q by a process scheduler until the system call SYS returns. The process is thus stopped throughout the entire waiting period, which saves processor time and frees the processor to carryout other processes. Once again, this functionality can be used very easily, by means of a simple function call SYS.

FIG. 6 shows how a typical system function call SYS of the type ‘send back result of voting’ function takes place. In order to keep the illustration simple and comprehensible, the voter system VS is shown as a single node within the network N although, in fact, it is preferably to be distributed in order to avoid a Single Point off Failure.

The present invention firstly realizes the movement of the distributed synchronization to the protocol stack PST and, secondly, the integration of this functionality in an efficient, high-speed and reliable interconnection protocol I, as it is required in embedded, fault-tolerant systems.

However, this does not mean that the protocol I can be used only for distributed synchronization. Due to its advantages (efficiency and reliability), it is a valuable alternative to other protocols, even in normal operation.

The above description of preferred embodiments of the present invention is given for the purpose of illustration, but is not exhaustive. Nor is the present invention limited to the precise form described here, but instead numerous modifications and changes are also possible within the context of the above disclosure.

Preferred embodiments have been described to illustrate the basic details of the present invention and practical applications to enable those skilled in the art to implement the present invention. Numerous additional modifications may be implemented for special applications.

What is claimed is:

1. A process for transmitting a data packet from a first system to a second system within a local area computer network using Ethernet communication technology, comprising:
identifying data packets by a unique identification-number built of an address existing in Ethernet protocol and a sequence-number;
acknowledging received packets to the first system by acknowledge-IDs; and
retransmitting the data packet by the first system on timeout for an acknowledge-ID to be received.

2. A process for transmitting data according to claim 1, wherein the address is a Medium-Access-Control-address.

3. A process for transmitting data according to claim 1, wherein subsequent unique identification-numbers are generated for every following packet by increasing the identification-number of an initial packet.

4. A process for transmitting data according to claim 1, wherein the first system upon sending the data packet frees memory for the data packet within a data buffer only after having validly received a corresponding Acknowledge-ID.

5. A process for transmitting data according to claim 4, wherein the second system upon receiving the data packet forgets an identification-number of the data packet only in case of the identification-number being smaller than a most recently acknowledged Acknowledge-ID provided by the first system.

6. A process for transmitting data according to claim 1, wherein a timeout for an acknowledge-ID to be received is calculated by a time the data packet was sent (t1), a receive time of the first system (tR) and a maximum processing time of the first system (tP2) to get a schedule and to start sending the data packet, according to: timeout=t1+tR+tP2.

7. A process for transmitting data according to claim 6, wherein the receive time for the first system is calculated from twice a maximum Ethernet travel time for the data packet plus a maximum processing time in the second system.

8. A process for transmitting data according to claim 1, wherein an error of transmission is detected by the first system on a number of retransmissions of the data packet exceeding a preset number of attempts.

9. A process for transmitting data according to claim 1, wherein an error of transmission is detected by the second system on a timeout if an identification-number has to be kept longer than a preset time.

10. A process for transmitting data according to claim 1, wherein every system within the local area computer network is an embedded system.

11. A process for transmitting data according to claim 1, wherein acknowledge-IDs are transmitted as part of the data packet.

12. A process for transmitting data according to one of the preceding claims, wherein the data packet sent by the first system includes the last acknowledged acknowledge-ID.

13. A voting mechanism in an error-tolerant system within a computer network using a process for transmitting data using Ethernet communication technology, comprising:
different computation systems, each carrying out an identical calculation and transmitting results in data packets identified by a unique identification-number built of an address existing in Ethernet protocol and a sequence-number and to retransmit the data packets on timeout for an acknowledge-ID to be received;
a local area computer network; coupled to said different computation systems, to implement a distributed synchronization in time of said different computation systems as part of a protocol stack for data transmission within said local area computer network; and
a voter system, coupled to said local area computer network, to acknowledge received packets to said different computation systems by acknowledge-IDs, to compare the results and to report a comparison result back to said different computation systems which do not start any further calculations until receipt of the comparison result.

14. A voting mechanism according to claim 13, wherein a result of a calculation from one of said different computation systems acting as a requesting system within said local area network is transmitted to said voter system using a single system call that is not returned until a voting process has been completed as a background operation and a result is present and fed back to the requesting system.

15. A voting mechanism according to claim 14, wherein a process that issued the system call is placed in a not-ready-queue within the requesting system until the system call returns, thus avoiding the requesting system having to wait actively for the result of the voting process.

16. A voting mechanism according to claim 13, wherein it is ensured that all said different computation systems involved send the result of the identical calculation to said voter system.

17. A voting mechanism according to claim 13, wherein said voter system is distributed within the local area computer network to avoid a Single Point of Failure.
